(19) United States
(12) Patent Application Publication
(10) Pub. No.: US 2006/0256063 A1
(43) Pub. Date: Nov. 16, 2006

(54) Display apparatus including source drivers and method of controlling clock signals of the source drivers

(75) Inventor: Chang-Ho An, Hwaseong-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/431,243

(22) Filed: May 9, 2006

(30) Foreign Application Priority Data
May 13, 2005 (KR) 10-2005-40207

(51) Int. Cl. G09G 3/36

(52) U.S. Cl. 345/98

(57) ABSTRACT

Provided is a source driver for a flat-panel display apparatus, in which clock signals are controlled to be operable in a desired timing condition. Clock signals of inoperative source drivers are deactivated to reduce the overall power consumption in the display apparatus.

### CROSS-REFERENCE TO RELATED PATENT APPLICATION

This U.S. non-provisional patent application claims priority to Korean Patent Application No. 2005-40207, filed on May 13, 2005, in the Korean Intellectual Property Office, the disclosure of which is incorporated by reference herein.

### BACKGROUND OF THE INVENTION

1. Field of the Invention

The present invention relates to flat-type display apparatuses and more particularly, to source drivers for flat-type display apparatuses.

2. Description of the Related Art

Flat-type display apparatuses are in higher demand than cathode ray tubes (CRT) because flat-type apparatuses require less power, weigh less, and can operate at lower voltages than a CRT of a similar screen size. The flat-type display apparatuses are primarily divided into non-emissive and emissive types. The non-emissive display apparatuses include liquid crystal display (LCD) units, while the emissive display apparatuses include plasma display panel (PDP), electro-luminescence display (ELD), light emitting diode (LED), vacuum fluorescent display (VFD), etc.

FIG. 1 is a block diagram illustrating a conventional flat-type display apparatus. The display apparatus 1000 receives image data signals, sync signals, and clock signals from a host (not shown), and displays color images on a panel 400.

The display apparatus 1000 includes a timing controller 10, a source driver section (or data driver) 20, a gate driver section (or scan driver section) 300, and the panel 400.

The timing controller 10 transfers the image data signals from the host under optimum timing conditions required by the source driver section 20 and the gate driver section 300. The timing controller 10 also outputs timing control signals for regulating the source driver section 20 and the gate driver section 300.

The source driver section 20 is composed of source drivers 21-2n. The source drivers 21-2n receive the image data signals (RGB Data) and the clock signals (Clock) from the timing controller 10, respectively, and correspondingly generate data-line drive signals to be transferred to pixels of the panel 400.

The gate driver section 300 is composed of gate drivers 310-3m0. The gate drivers 310-3m0 generate scan signals, which activate respective scan lines of the panel 400 in sequence, in response to the control signals (Timing Control).

The panel 400 includes a plurality of intersecting scan and data lines, where pixels are connected between the scan and data lines.

A RSDS (reduced swing differential signaling) interface can be used to interface between the timing controller 10 and the source drivers 21-2n. The RSDS interface includes a RSDS data receiver and a RSDS clock receiver. When the RGB data is 8 bits, 24 data buses and a RSDS data receiver constructed of 12 amplifiers receiving 2 differential input signals (DxxP, DxxN) are used to restore a transmission signal at the source drivers. When the RGB data is 6 bits, 18 data buses and a RSDS data receiver constructed of 9 amplifiers receiving 2 differential input signals (DxxP, DxxN) are used. The RSDS clock receiver is composed of a single amplifier to restore a transmission signal from two differential clock signals, CLKP and CLKN, regardless of the number of data bits.

For example, when the RGB data is 8 bits, the 12 data amplifiers and a single clock amplifier of the first source driver 21 of the source driver section 20 are driven by RGB data supplied from the timing controller 10. At this time there is no input of RGB data to the other source drivers 22-2n. The data amplifiers of the RSDS data receivers of the other source drivers 22-2n are deactivated but the clock amplifiers are activated. When the second source driver 22 of the section 20 is operating, the 12 data amplifiers and single clock amplifier of the second source driver 22 are activated together with the clock amplifiers of the other source drivers, 21 and 23-2n. Thus, there is a problem of unnecessary power consumption in the conventional flat-type display apparatus because the clock amplifiers of the inactive source drivers are conductive in addition to the active source driver.

### SUMMARY OF THE INVENTION

An exemplary embodiment of the invention provides a display apparatus including a panel, a timing controller, and driver section. The timing controller generates a clock signal and an operation start signal. The driver section activates the panel in response to the clock signal and the operation start signal. The driver section includes a plurality of source drivers each of which enables or disables an internal clock signal in response to an operation start signal output from a prior source driver.

Each of the plurality of source drivers may comprise a start-pulse I/O generator. The start-pulse I/O generator receives an operation start signal and a clock control signal. The clock control signal is used to enable or disable the internal clock signal of the start-pulse I/O generator. The start-pulse I/O generator delays the operation start signal and generates a delayed operation start signal to be output to a subsequent source driver.

Another exemplary embodiment of the invention provides a display apparatus including a panel, a timing controller, and driver section. The timing controller provides a clock signal, a clock enabling signal, and an operation start signal. The driver section activates the panel in response to the clock signal and the operation start signal. The driver section includes a plurality of source drivers each of which enables or disables an internal clock signal in response to the clock enabling signal output from a prior source driver.

The source drivers may include a start-pulse I/O generator. The start-pulse I/O generator will generate a delayed operation start signal and a delayed clock enabling signal to be transferred to the next source driver.

Another exemplary embodiment of the invention provides a source driver of a display apparatus including a clock receiver and a controller. The clock receiver receives a clock signal from an external source and the controller activates the clock receiver in response to an operation start signal.

Another exemplary embodiment of the invention provides a method of controlling a clock signal for a plurality of source drivers. The method is comprised of the following steps: receiving an operation start signal from a prior source driver; activating a clock control signal of the current source driver in response to the operation start signal and enabling the clock signal; generating a delayed operation start signal and outputting the delayed operation start signal to a next source driver, before completing an operation of the current source driver; and deactivating the clock control signal of the current source driver after generating the delayed operation start signal and disabling the clock signal.

### BRIEF DESCRIPTION OF THE DRAWINGS

The above and other features of the present invention will become more apparent by describing in detail exemplary embodiments thereof with reference to the attached drawings in which:

FIG. 1 is a block diagram of a conventional flat-type display apparatus;

FIG. 2 is a block diagram illustrating functional correlations among source drivers according to an exemplary embodiment of the invention;

FIG. 3 is a block diagram of a source driver according to an exemplary embodiment of the invention;

FIG. 4 is a timing diagram of a control scheme for an RSDS clock receiver of a first source driver according to an exemplary embodiment of the invention;

FIG. 5 is a timing diagram illustrating a control scheme for an RSDS clock receiver of a first source driver according to an exemplary embodiment of the invention;

FIG. 6 is a timing diagram of a control scheme for an RSDS clock receiver of a first source driver according to an embodiment of the invention;

FIG. 7 is a block diagram illustrating functional correlations among the source drivers according to according to an exemplary embodiment of the invention.; and

FIG. 8 is a block diagram illustrating a modified version of the interface between the timing controller and the source drivers shown in FIG. 2.

### DETAILED DESCRIPTION OF EXEMPLARY EMBODIMENTS

Hereinafter, exemplary embodiments of the present invention will be described in detail with reference to the attached drawings.

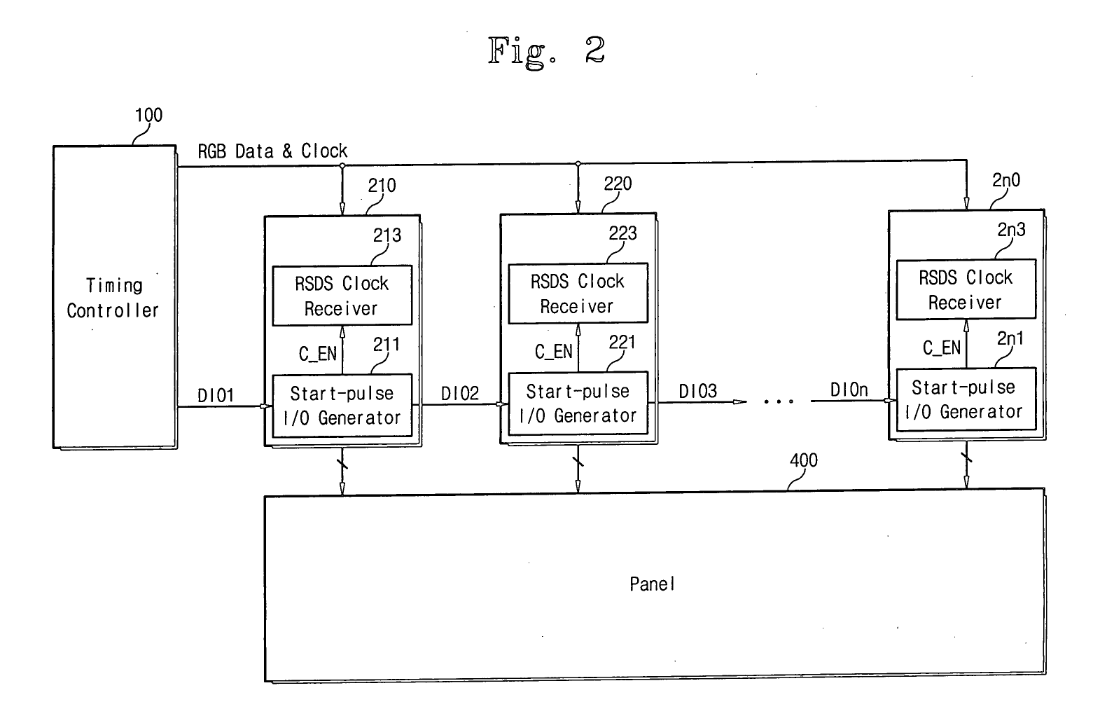

FIG. 2 is a block diagram illustrating functional correlations among source drivers according to an exemplary embodiment of the invention. Source drivers 210-2n0 receive image data signals (RGB Data) and a clock signal (Clock) from a timing controller 100 and then output data-line drive signals to a panel (e.g., an LCD panel) 400.

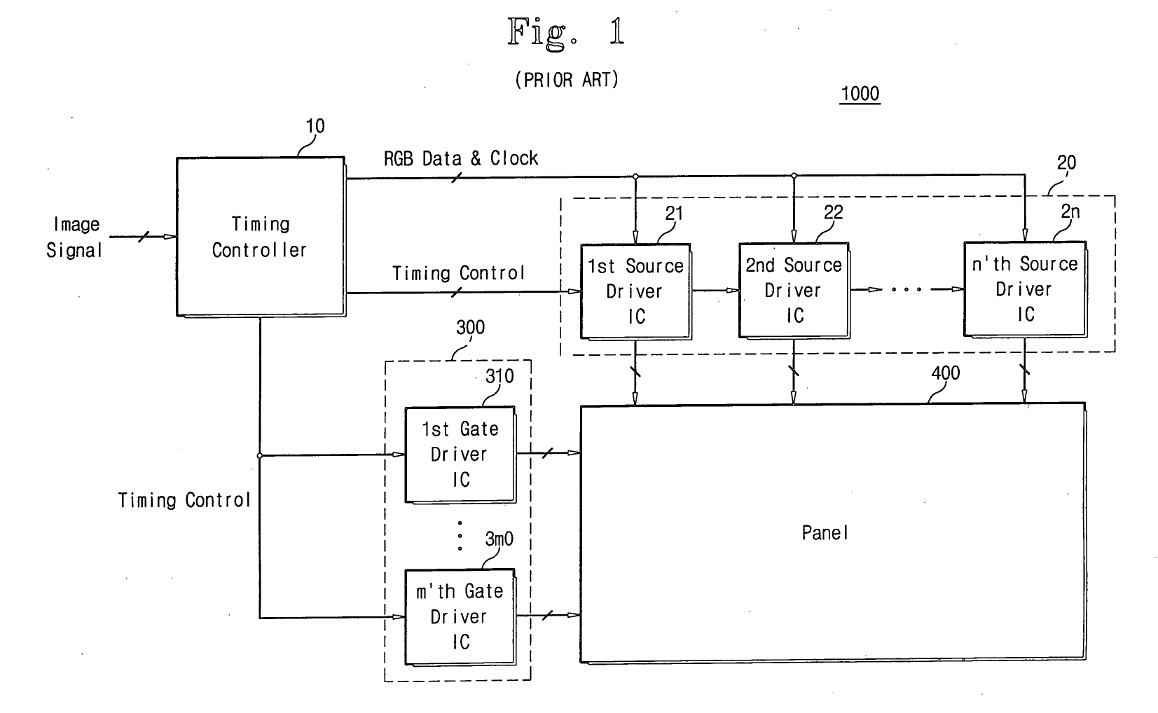

The source drivers 210-2n0 are each comprised of start-pulse I/O generators 211-2n1 and RSDS clock receivers 213-2n3. The start-pulse I/O generator 211 of the first source driver 210 receives a first DIO signal DIO1, which acts as a chip-operation start signal, from the timing controller 100. The start-pulse I/O generator 211 then generates a second DIO signal DIO2 that is a chip-operation start signal for the second source driver 220. The RSDS clock receivers 213-2n3 function to restore clock signals, CLKP and CLKN, which are supplied from the timing controller 100, for use in the source drivers 210-2n0. As described before with respect to FIG. 1, there is unnecessary power consumption regardless of which source driver is active because conventional RSDS clock receivers are all normally active. Inputs of the DIO signals are operation start signals for the start-pulse I/O generators 211-2n1. The start-pulse I/O generators 211-2n1 output a clock enabling/disabling signal C_EN for controlling the corresponding RSDS clock receivers 213-2n3 to enable the clock signals. As a result, only the clock signals of the source drivers 210-2n0 receiving the DIO signals DIO1-DIOn are activated.

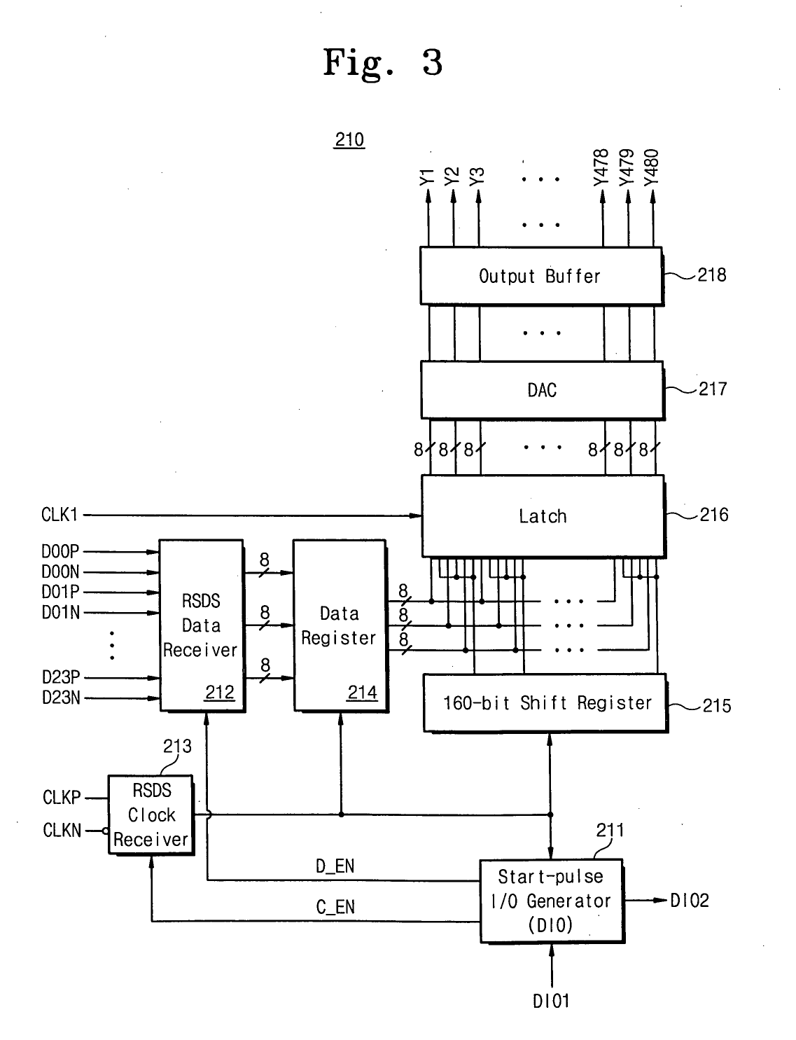

FIG. 3 is a block diagram of the first source driver 210 according to an exemplary embodiment of the invention. Referring to FIG. 3, the source driver 210 is comprised of the start-pulse I/O generator (or DIO block) 211, an RSDA data receiver 212, the RSDS clock receiver 213, a data register 214, a 160-bit shift register 215, a latch 216, a digital-to-analog converter (DAC) 217, and an output buffer 218.

The start-pulse I/O generator 211 is provided to supply signals for controlling components of the first source driver 210. The first source driver 210 begins to operate after accepting the DIO signal DIO1. The start-pulse I/O generator 211 outputs a data signal D_EN to control the RSDS data and the clock signal C_EN to enable or disable clock receivers 212 and 213 with reference to the clock signals notifying data transmission information to the shift register 215. The start-pulse I/O generator 211 also outputs a DIO output signal DIO2 that activates the second source driver 220.

The RSDS data receiver 212 functions to restore the RGB data signals D00P-D23P input from the timing controller 100, and to transfer the restored RGB data signals to the data register 214. The 8-bit RSDS data receiver 212 includes 12 data amplifiers each of which receives differential signals from among the RGB data signals D00P-D23P output from the timing controller 100. The 12 data amplifiers are controlled by the data signal D_EN.

The RSDS clock receiver 213 restores the clock signals CLKP and CLKN input from the timing controller 100, and then provides the restored signals as clock signals for the data register 214 and the shift register 215. A clock amplifier in the RSDS clock receiver 213 is controlled by the clock signal C_EN output from the start-pulse I/O generator 211.

The data register 214 stores digital-RGB data signals that are restored through the RSDS data receiver 212.

The 160-bit shift register 215 sequentially outputs data clock signals to control the timing for storing the RGB data signals into the latch 216 from the data register 214.

The latch 216 temporarily stores the RGB data signals in control of the data clock signals output from the shift register 215 after a digital-RGB data signal is stored in the data register 214.

The DAC 217 transforms the digital-RGB data signals into analog video signals.

The output buffer 218 outputs signals for driving unit pixels of the panel 400, in response to the analog video signals output from the DAC 217.

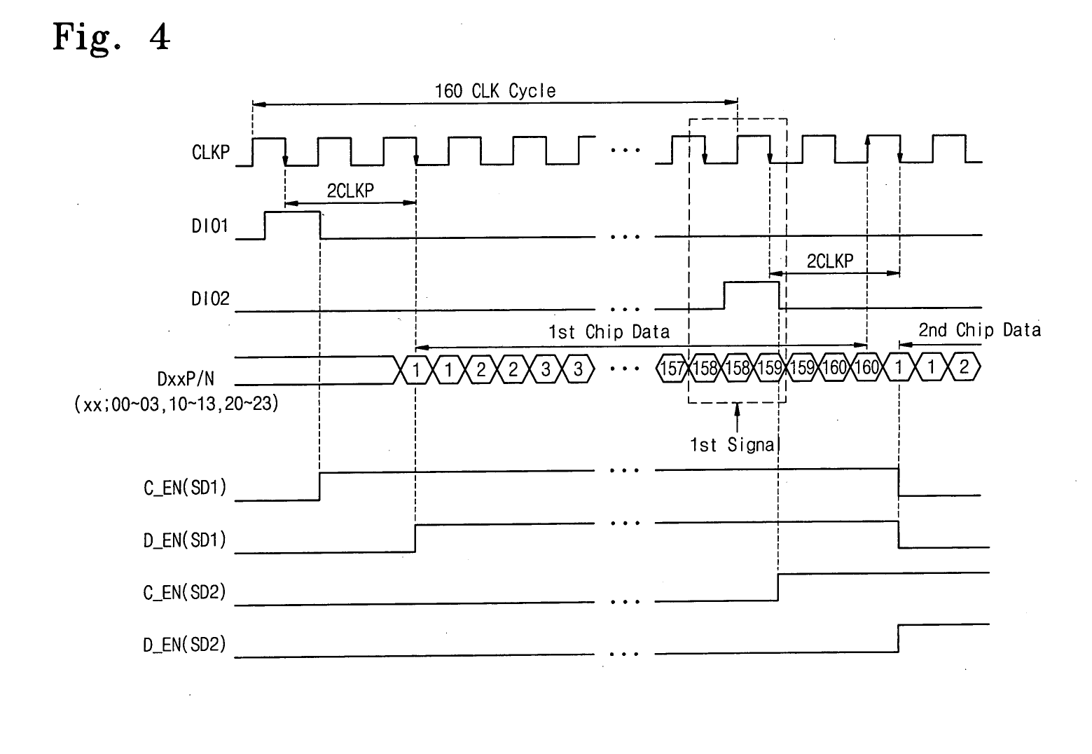

FIG. 4 is a timing diagram illustrating a control scheme for the RSDS clock receiver 213 of the first source driver 210 according to an exemplary embodiment of the invention. This embodiment directly utilizes the DIO input signal DIO1 output from the timing controller 100 as a chip enabling/disabling signal (i.e., the chip-operation start signal) of the first source driver 210. When the DIO input signal DIO1 for driving the first source driver 210 is output from the timing controller 100, the RGB data signals DxxP/DxxN are loaded on the shift register 215 after a predetermined time (e.g., two clock cycles) set for the interface between the timing controller 100 and the first source driver 210. The start-pulse I/O generator 211 of the first source driver 210 generates the DIO output signal DIO2, to operate the second source driver 220 for a predetermined time. If the second source driver 220 receives the DIO signal DIO2 from the first source driver 210, the RGB data signals DxxP/DxxN are loaded on the shift register 215 of the second source driver 220 after a predetermined time.

In the conventional art, the DIO signals DIO1-DIOn are used to control operational timings by loading data on the shift registers 215 of the source drivers 210-2n0, but in an exemplary embodiment of the invention, a first one of the DIO signals DIO1-DIOn is used as a chip enabling/disabling signal for the current and next source drivers. In other words, if the first signal is provided from the start-pulse I/O generator 211, the start-pulse I/O generator 211 outputs data and clock disabling signals for deactivating the RSDS data and clock receivers 212 and 213, in a predetermined time with reference to data transmission information of the shift register 215. Subsequently, if the first signal is applied to the next source driver (i.e., the second source driver 220) as the DIO input signal DIO2, the start-pulse I/O generator 221 of the second source driver 220 outputs the data and clock disabling signals for deactivating the RSDS data and clock receivers 222 and 223 of the second source driver 220.

The data and clock enabling/disabling signals D_EN(SD1) and C_EN(SD1) shown in FIG. 4 are supplied by the start-pulse I/O generator 211 of the first source driver 210. The clock enabling signal C_EN for the first source driver 210 is activated after the input of the first signal. The data enabling signal D_EN is activated after a predetermined time from the input of the first signal. The data and clock enabling/disabling signals D_EN(SD2) and C_EN(SD2) are supplied by the start-pulse I/O generator 221 of the second source driver 220.

Referring to the first signal and the data transmission information of the shift register 215, the start-pulse I/O generator 211 of the first source driver 210 outputs the data and clock enabling/disabling signals D_EN and C_EN for controlling the operations of the RSDS data and clock receivers 212 and 213, but deactivates the data and clock amplifiers of inoperative source drivers, thereby reducing overall power consumption in the display apparatus.

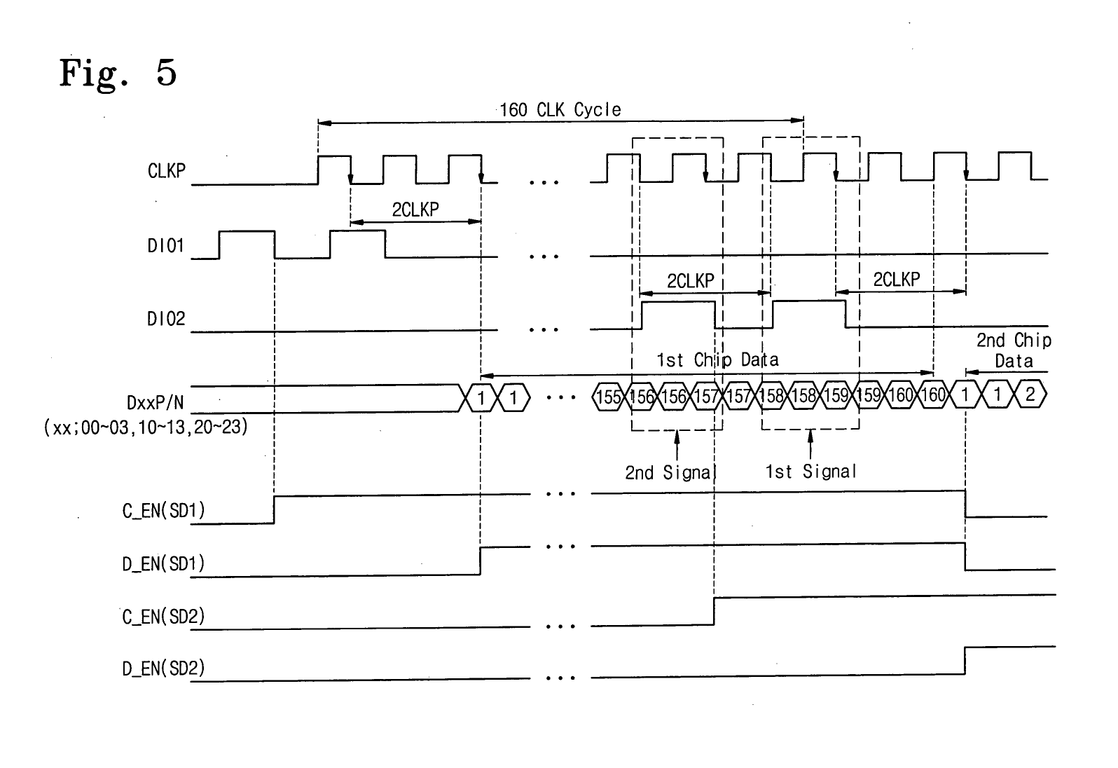

FIG. 5 is a timing diagram illustrating a control scheme for the RSDS clock receiver 213 of the first source driver 210 according to an exemplary embodiment of the invention. In FIG. 5, the timing controller 100 twice generates DIO input signals in sequence within a predetermined time. The sequentially generated DIO signals are each used as chip enabling signals for the source drivers 210-2n0. The first signal among the DIO input/output signals DIO1-DIOn, as the first signal of FIG. 4, controls operational timings by loading data on the shift registers 215-2n5 of the source drivers 210-2n0, respectively. The first signal of FIG. 5 is used for deactivating the RSDS data and clock receivers 212 and 213 of the first source driver 210 and activating the RSDS data receiver 222 of the next (second) source driver 220. The second signal is used for activating the RSDS clock receiver 223 of the second source driver 220. The second signal is used instead of the first signal for activating the next (second) RSDS clock receiver 223 (i.e., the RSDS clock driver of the second source driver 220) to ensure enough time for stabile operational performance after enabling the clock signal CLKP.

For instance, if there are inputs of the first and second signals with a predetermined interval, into the first source driver 210 from the timing controller 100, the clock signal CLKP is activated after a time in response to the second signal and the start-pulse I/O generator 211 outputs the clock enabling signal C_EN to drive the RSDS clock receiver 213 of the first source driver 210. Then, after a predetermined time, the start-pulse I/O generator 211 outputs the data enabling signal D_EN, in response to the first signal output from the timing controller 100, to drive the RSDS data receiver 212 of the first source driver 210.

Towards the end of the operation of the first source driver 210, the start-pulse I/O generator 211 outputs the DIO output signal DIO2 to control the second source driver 220 with reference to the data transmission information of the shift register 215. When the first signal is output from the start-pulse I/O generator 211 of the first source driver 210, data and clock disabling signals for deactivating the RSDS data receiver 212 and the RSDS clock receiver 213, are also supplied by the start-pulse I/O generator 211 after a predetermined time with reference to the data transmission information of the shift register 215. Further, if the second source driver 220 accepts the first signal as the DIO input signal DIO2, the start-pulse I/O generator 221 of the second source driver 220 outputs the data enabling signal D_EN, after a predetermined time to activate the RSDS data receiver 222 of the second source driver 220. When the second source driver 220 receives the DIO input signal DIO2, the start-pulse I/O generator 221 of the second source driver 220 outputs the clock enabling signal C_EN, after a predetermined time to activate the RSDS clock receiver 223 of the second source driver 220.

Referring to the first and second signals, and the data transmission information of the shift register 215, the start-pulse I/O generator outputs the data and clock enabling/disabling signals D_EN and C_EN for controlling the operations of the RSDS data and clock receivers, but deactivates the data and clock amplifiers of inoperative source drivers, thereby reducing overall power consumption in the display apparatus.

The clock and data enabling/disabling signals, C_EN(SD1) and D_EN(SD1), are provided from the start-pulse I/O generator 211 of the first source driver 210. The clock enabling signal C_EN for the first source driver 210 is activated after the input of the second signal. The data enabling signal D_EN is activated after a predetermined time from the input of the first signal. The data and clock enabling/disabling signals, D_EN(SD2) and C_EN(SD2), are provided from the start-pulse I/O generator 221 of the second source driver 220.

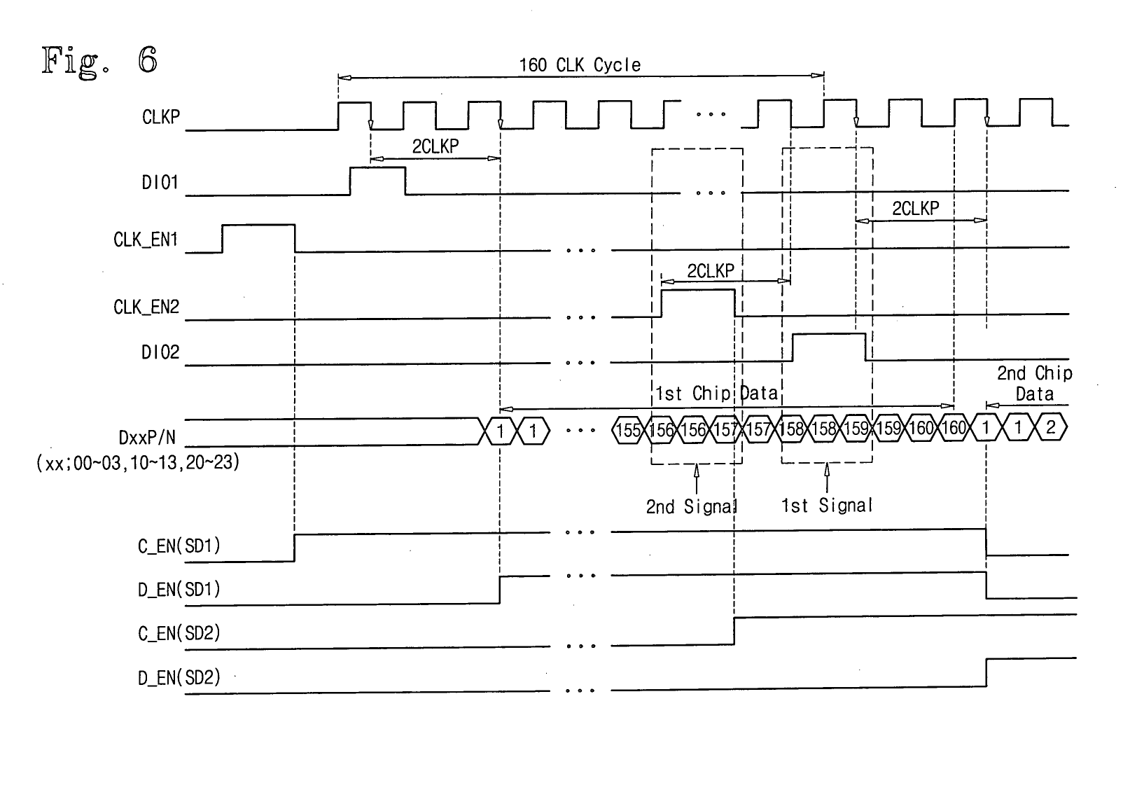

FIG. 6 is a timing diagram illustrating a control scheme for an RSDS clock receiver 213 of the first source driver 210 according to an exemplary embodiment of the invention. This embodiment shown in FIG. 6 is configured to receive a clock operation signal CLK_EN1 from the timing controller 100 by adding a bus line. The clock operation signal CLK1_EN1 functions like the second signal of FIG. 5, and a first one of the DIO input/output signals DIO1-DIOn is the same as the first signal of FIG. 5. The additional bus line is needed to output the clock operation signals CLK_EN1-CLK_ENn from the start-pulse I/O generators of the source drivers to the next source drivers 220-2n0.

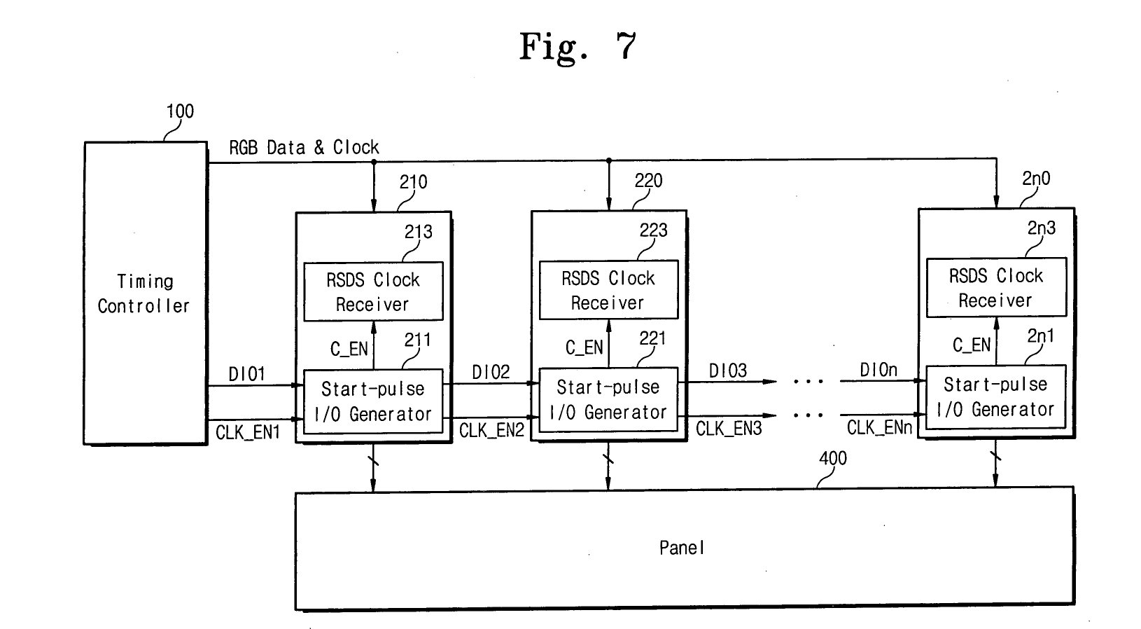

FIG. 7 is a block diagram illustrating functional correlations among source drivers according to an exemplary embodiment of the invention. Different from FIG. 2, FIG. 7 includes an additional bus line for outputting the clock operation signals CLK_EN1-CLK_ENn. The first source driver 210 receives the clock operation signal CLK_EN1 from the timing controller 100, and the start-pulse I/O generator 211 outputs the clock enabling/disabling signal C_EN to control the clock signal of the RSDS clock receiver 213. The start-pulse I/O generator 211 of the first source driver 210 outputs the clock operation signal CLK_EN2, which is output to the second source driver 220 across the bus line to control the clock signal of the second source driver 220.

In the first source driver 210 of the source driver section 200 with 8-bit data-transmission source drivers, 12 data amplifiers and a single clock amplifier are driven by RGB data supplied by the timing controller 100. At this time there is no input of RGB data to the other source drivers 220-2n0. The data amplifiers of the RSDS data receivers and the clock amplifiers are deactivated by disabling the clock signals CLKP through the methods shown in FIGS. 4-6, thereby reducing power consumption in a display apparatus.

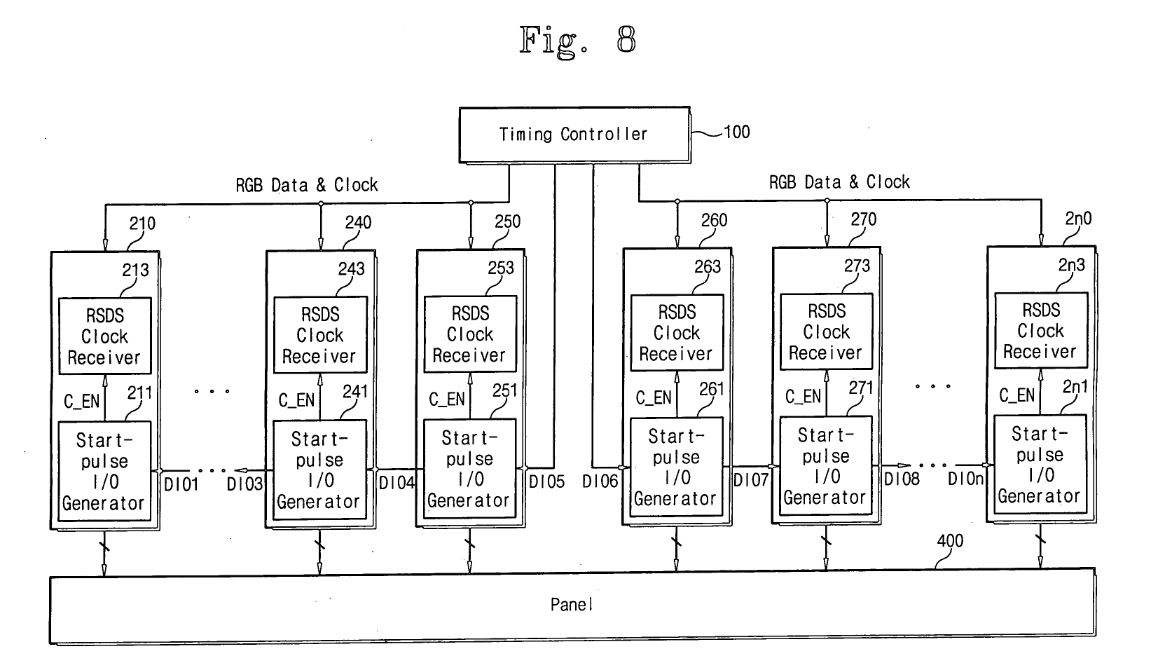

FIG. 8 is a block diagram illustrating a modified version of the interface between the timing controller 100 and the source drivers 210-2n0 shown in FIG. 2. The interface is configured to be a single-mode scheme that conducts sequential interfacing operations between the timing controller 100 and the source drivers 210-2n0. The interfacing operations between the timing controller 100 and the source drivers 210-2n0 start from two source drivers at the center portion of the source drivers (e.g., the fifth and sixth source drivers 250 and 260 if n=10). Compared with FIG. 2, the interface shown in FIG. 8 is referred to as a dual mode or T-division interfacing scheme. With the interfacing scheme shown in FIG. 8, times for transferring data or clock signals to the source drivers are more reduced than a single-mode interfacing scheme of FIG. 2. The dual-mode interfacing scheme is usually adopted to activate a high-resolution panel.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A display apparatus comprising:
a panel;
a timing controller providing a clock signal and an operation start signal; and
a driver section activating the panel in response to the clock signal and the operation start signal,
wherein the driver section includes a plurality of source drivers each of which enables or disables an internal clock signal in response to the operation start signal output from a prior source driver.

2. The display apparatus as set forth in claim 1, wherein the operation start signal is a control signal to enable chip operations of the source drivers.

3. The display apparatus as set forth in claim 2, wherein a first source driver among the plurality of source drivers receives the operation start signal from the timing controller.

4. The display apparatus as set forth in claim 2, wherein two source drivers among the plurality of source drivers receive the operation start signal from the timing controller at substantially the same time.

5. The display apparatus as set forth in claims 3, wherein the source driver comprises:
a start-pulse I/O generator receiving the operation start signal, delaying the operation start signal and a clock control signal to enable or disable the internal clock signal, and outputting the delayed operation start signal to the next source driver.

6. The display apparatus as set forth in claim 5, wherein the clock control signal is activated in response to the operation start signal input to the start-pulse I/O generator, enabling the internal clock signal.

7. The display apparatus as set forth in claim 6, wherein the clock control signal is deactivated after output of the delayed operation start signal to the next source driver, disabling the internal clock signal.

8. The display apparatus as set forth in claim 7, wherein the delayed operation start signal is activated and then applied to the next source driver before completing operations of the source drivers.

9. The display apparatus as set forth in claim 8, wherein the operation start signal is output with a pulse prior to activation of the source drivers.

10. The display apparatus as set forth in claim 8, wherein the operation start signal is output in a shape of two pulses having an interval of time from each other prior to activation of the source drivers.

11. The display apparatus as set forth in claim 10, wherein the clock control signal is activated in response to a first one of the two pulses, enabling the internal clock signal.

12. The display apparatus as set forth in claim 11, wherein the first pulse is received as a clock enabling signal across a bus line separate from a bus line the operation start signal is transmitted across.

13. A display apparatus comprising:
a panel;
a timing controller providing a clock signal, a clock enabling signal, and an operation start signal; and
a driver section activating the panel in response to the clock signal and the operation start signal,
wherein the driver section includes a plurality of source drivers each of which enables or disables an internal clock signal in response to the clock enabling signal output from a prior source driver.

14. The display apparatus as set forth in claim 13, wherein the operation start signal is a control signal to enable chip operations of the source drivers.

15. The display apparatus as set forth in claim 14, wherein a first source driver among the plurality of source drivers receives the clock enabling signal from the timing controller.

16. The display apparatus as set forth in claim 15, wherein each source driver comprises:
a start-pulse I/O generator receiving the clock enabling signal, delaying the operation start signal and the clock enabling signal, and generating a clock control signal to enable or disable the internal clock signal, and outputting a delayed operation start signal and a delayed clock enabling signal to the next source driver.

17. The display apparatus as set forth in claim 16, wherein the clock control signal is activated in response to the operation start signal input to the start-pulse I/O generator, enabling the internal clock signal.

18. The display apparatus as set forth in claim 17, wherein the clock control signal is deactivated after output of the delayed operation start signal to the next source driver, disabling the internal clock signal.

19. The display apparatus as set forth in claim 18, wherein the delayed clock enabling signal and the delayed operation start signal are generated with an interval of time apart from each other and then applied to the next source driver, before completing operations of the source drivers.

20. A source driver of a display apparatus, comprising:
a clock receiver receiving a clock signal from an external source; and
a controller activating the clock receiver in response to an operation start signal.

21. The source driver as set forth in claim 20, wherein the operation start signal is supplied from an external source to activate the source driver.

22. The source driver as set forth in claim 21, wherein the controller provides a clock control signal to the clock receiver in response to the operation start signal.

23. The source driver as set forth in claim 22, wherein the clock receiver is active for a predetermined time.

24. The source driver as set forth in claim 23, wherein the predetermined time is a duration for processing image data and generating a drive signal by the source driver.

25. A method of controlling a clock signal for a plurality of source drivers, the method comprising:
receiving an operation start signal from a prior source driver;
activating a clock control signal of a current source driver in response to the operation start signal and enabling the clock signal;
generating a delayed operation start signal that is to be transferred to a next source driver, before completing an operation of the current source driver; and
deactivating the clock control signal of the current source driver after a generating the delayed operation start signal and disabling the clock signal.

26. The method as set forth in claim 25, wherein the plurality of source drivers are connected in series, each source driver generating an operation start signal to enable a chip operation of the next source driver.

27. The method as set forth in claim 26, wherein the operation start signal is a start signal to enable a chip operation of a first source driver of the source drivers.

28. The method as set forth in claim 27, wherein the operation start signal is output with a pulse prior to activation of the source drivers.

29. The method as set forth in claim 27, wherein the operation start signal is output with two pulses prior to activation of the source drivers.

30. The method as set forth in claim 29, wherein the clock control signal is activated in response to a first one of the two pulses, enabling the internal clock signal.

31. The method as set forth in claim 30, wherein the first pulse is received as a clock enabling signal across a bus line separate from a bus line the operation start signal is transmitted across.
